(19) United States
(12) Patent Application Publication
(10) Pub. No.: US 2005/0208186 A1
(43) Pub. Date: Sep. 22, 2005

(54) Vendable sandwich and food products

(76) Inventor: Mark R. Kirkland, Sandy, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/806,252

(22) Filed: Mar. 22, 2004

(51) Int. Cl. A23B 4/00

(52) U.S. Cl. 426/120

(57) ABSTRACT

Food items, and principally sandwiches, are disclosed as being packaged for dispensing from vending machines conventionally structured for vending containerized, that is, canned or bottled, beverages, such as soft drinks and the like. The present invention further discloses means for combining different food items in one packaging arrangement for dispensing from a vending machine conventionally structured for vending containerized beverages.

### BACKGROUND OF THE INVENTION

1. Field of the Invention

This invention relates to vendable food and/or non-food products, and specifically relates to food products packaged in a manner that make the product vendable from a vending machine otherwise structured for vending canned or bottled beverages.

2. Description of Related Art

The vending industry produces annual sales in the billions of dollars, based principally on the sales of beverages from vending machines structured to dispense canned and bottled soft drinks. A large number of sales also come from vending machines structured to dispense snack items such as chips, cookies and candy, and to a lesser extent, sales are generated from vending machines structured to dispense non-comestible items in suitable venues, such as vending laundry detergent at laundromats.

Vending machines are found virtually anywhere, including remote and relatively uninhabited areas. Vending machines are so prevalent because they meet the needs of consumers in providing convenient and instantaneous sources of refreshment. However, as noted, vending machines are structured to vend a particular product or class of products, and/or are structured to vend a particular size or shape of packaging for a given product. That is, vending machines are structured to dispense either aluminum cans or plastic bottles of soft drink beverages, but not both.

Thus, it has been recognized for over a decade that while providing a soft drink dispensing vending machine meets the largest need for the consumer, consumers often want additional food items to accompany a selected beverage. This is particularly true in these hurried times when it is not always possible to pack a lunch or go to a restaurant to eat every day. People become more inclined to seek a quick and convenient, if not inexpensive, means of satisfying their hunger by going to the closest vending machine. However, it has also been recognized that not all venues where vending machines are placed are sized for having multiple numbers of vending machines—one for dispensing canned or bottled beverages and one for dispensing food items.

U.S. Pat. No. 6,006,945 to the present inventor describes the packaging of snack foods and non-comestible items in cans sized and traditionally shaped for vending from machines structured for vending canned soft drinks. The '945 patent further describes structures for containers that enable the snack food-sized items to be removed from the container. While the '945 patent describes a means for providing snack items, or non-comestibles, it does not address the means by which more substantial items of food, such as a sandwich, can be provided in a container that is sized for dispensing from a vending machines structured for vending canned or bottled beverages. Nor does it address means for dispensing multiple products from one container.

Thus, it would be advantageous in the art to provide a containerized sandwich which can be dispensed from a vending machine sized to dispense canned or bottled beverages, such as soft drinks, so that the consumer may purchase both a food and beverage item from the same vending machine, thereby expanding the availability of food product choices to the consumer. It would be further advantageous to provide containerized combinations of food products, or food and non-food items, that are packaged in a manner which allows the consumer to buy a full meal compliment of food items from a single vending machine.

### BRIEF SUMMARY OF THE INVENTION

In accordance with the present invention, a containerized food product, in the nature of a sandwich or equivalent type of food product, is provided for being dispensed from a vending machine that is otherwise structured for vending containerized beverages, such as soft drinks, milk, juice or other comestible liquids. The containerized food product may further be combined in a tandem packaging arrangements with other food products in the nature of snack items, such as chips, nuts, cookies, candy, yogurt, puddings, or any variety of other snacking products, or with non-food items.

The present invention has the objective of providing the consumer with a choice of more substantial food product choices from a single vending machine. In one aspect of the invention, a containerized sandwich or sandwich-type product is sized and shaped for vending from a vending machine that is structured to dispense liquid beverages in similar sized containers. That is, for example, in a first embodiment, a sandwich or sandwich-like product may be packaged in a twelve ounce aluminum can for dispensing from a vending machine that is structured for vending twelve ounce aluminum cans of soft drinks or other beverages.

In a similar embodiment, a sandwich or sandwich-like product may be packaged in a container that is sized and shaped to be dispensed from a vending machine otherwise structured for vending bottled beverages, such as twenty ounce plastic bottles. Although twelve ounce aluminum cans and twenty ounce plastic bottles are currently the two most prevalent sizes and forms of containers for vendable soft drinks and other beverages, the size and particular shape of the container for the sandwich or sandwich-like product, in accordance with the present invention, may be any suitable size, shape or dimension that is vendable from a machine that is structured principally for vending beverages, the objective being to provide to the consumer food products and beverages from a single vending machine.

Further in accordance with the present invention, disparate food products, or food and non-food products, may be provided in a tandem containerized package the overall size and dimension of which is suited for dispensing from a vending machine that is otherwise structured for vending beverages, such as soft drinks, in cans, bottles or other conventionally-known containers. For example, a tandem container may be structured with a main container portion that is sized for containing a sandwich or sandwich-like product, and a secondary container portion that is detachably secured to the main container portion and which is sized to contain a serving size of a snack-type product, such as potato or corn chips, nuts, cookies, candy, yogurt, gelatin, pudding, etc. The overall size and dimension of the tandem container, however, is generally equivalent to either a twelve ounces aluminum can or twenty ounce bottle, by way of example only.

The containerized food products described herein are particularly provided for vending from a vending machine structured to dispense liquid beverages so that the consumer may have a wider variety of food choices vendable from a single vending machine. However, as is conventionally know, such containerized products need not be strictly available through vending machines, but may be available from retail store shelves, much in the same manner that aluminum canned drinks and plastic or glass bottle-containing beverages are available on grocery or retail store shelves. The invention is not meant to be limited strictly to vending of such containers.

### BRIEF DESCRIPTION OF THE SEVERAL VIEWS OF THE DRAWINGS

In the drawings, which illustrate what is currently considered to be the best mode for carrying out the invention:

FIG. 1 is a perspective view, in partial phantom, of a first embodiment of the invention comprising a traditionally-sized vendable soft drink container filled with a sandwich product;

FIG. 2 is a perspective view in partial cutaway of a second embodiment of the present invention where a sandwich and snack product are packaged together in a traditionally-sized vendable soft drink container;

FIG. 3 is an exploded perspective view of a third embodiment of the present invention where a sandwich product and a snack product are packaged in separate units combined together for dispensing from a conventional vending machine structured for vending canned or bottled soft drinks;

FIG. 4 is an exploded perspective view of a fourth embodiment of the present invention where a sandwich product and snack product are packaged in separate containers that approximate the size of vendable twenty ounce soft drink containers; and

FIG. 5 is an exploded perspective view of a third embodiment of the present invention illustrating a combination of a drink and a snack product in a single packaging unit.

### DETAILED DESCRIPTION OF THE INVENTION

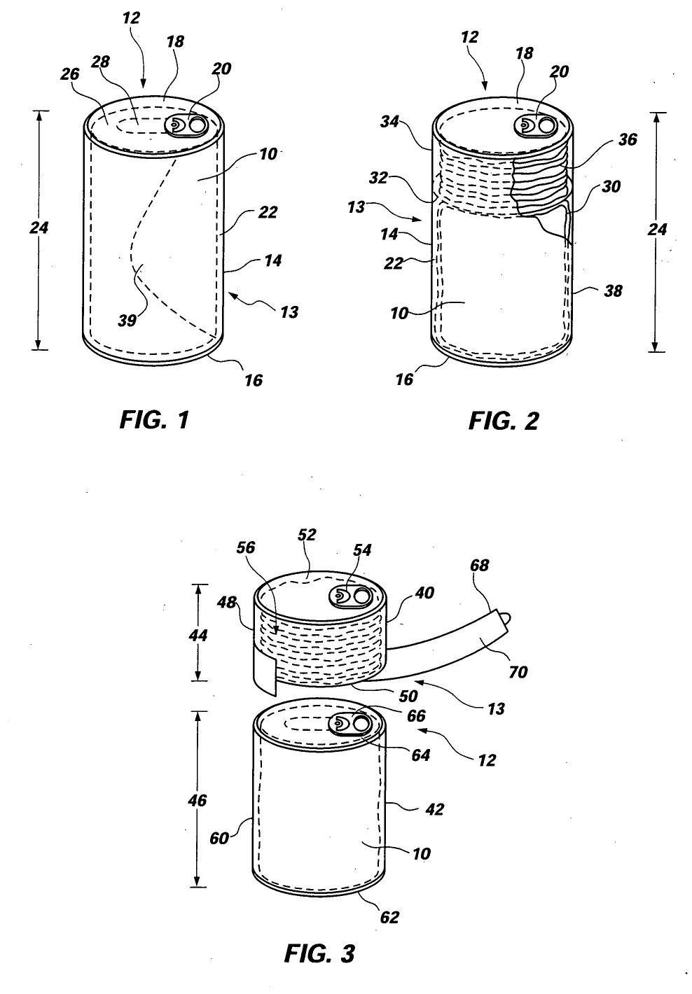

FIG. 1 depicts a first embodiment of the invention which comprises a containerized sandwich or sandwich-like product 10 in a container 12. The container 12 comprises a food product-enclosing portion 13, which may generally be a cylindrical portion 14, a bottom 16 which encloses the cylindrical portion 14 at one end thereof, and a top 18 which encloses the cylindrical portion 14 at the opposing end thereof. The top 18 of the container 12 may be provided with an opening mechanism 20 that enables the top 18 to be removed from the cylindrical portion 14 to provide access to the interior 22 of the container 12. Other opening mechanisms may be employed, however, as further described hereinafter.

As depicted in FIG. 1, the container 12 has a height dimension 24 and shape (i.e., cylindrical) which approximates the shape and dimension of a twelve ounce aluminum beverage can so that the container 12 is suitable for placement in and dispensing from a vending machine that is structured to vend twelve ounce aluminum beverage cans. Indeed, the container 12 may be made of aluminum, or the container 12 may be made of any other suitable material, such as plastic, cardboard, tin or other suitable material. It should be noted that the container 12 may be structured with a weight element (not shown) that adds weight to the container and its contents to approximate the weight of a similarly sized and shaped beverage can so that the container 12 may be readily vended from a vending machine.

As used herein, “sandwich or sandwich-like” product is meant to imply and include any type of combined food product that generally comprises a bread or bread-like element and, preferably, any type of filler material, such as meat, cheese, fish, vegetables, peanut butter and jelly, or combinations thereof. The use of “sandwich or sandwich-like” product is not meant to be limited to the conventionally-known type of sandwich comprising two slices of bread with filler material therebetween, but is meant to include products made, for example, of tortillas (e.g., tortilla wraps), pita bread, buns, bagels or any other conceivable bread-like materials or substitutes therefor which generally are suitable for enclosing a filler material.

It should be noted, however, that the sandwich-like product may include a bread-like product that is not necessarily associated directly with a filler material, such a bagel; but the containerized product of the present invention contemplates providing filler materials for use with the bread-like product, whether or not such filler product is necessarily in direct contact with the bread-like product at the packaging and containerizing stage. Thus, for example, the container of the present invention may include a sandwich-like product that comprises one or more bagels, and a filler material, such as cream cheese, may be provided in the container as a separate unit that may be spread on the bagel or bagels by the consumer following opening of the container, as described more fully hereinafter.

By way of example only, the sandwich product 10, as illustrated in FIG. 1, may comprise an outer bread material 26 and an inner filler material 28. The sandwich product 10 may be formed in any suitable manner for placement within the container 12. For example, the sandwich product 10 may be formed in a conventional method where a filler material (e.g., tuna with mayonnaise) is positioned within a cylindrically formed and cooked bread material 26 and is positioned within the container 12, followed by sealing of the container 12 in a conventionally-known method.

Alternatively, the sandwich product 10 may be formed by placing a filler material 28, such as a precooked meat product (e.g., sausage), within an uncooked bread-like material 26 (i.e., uncooked or partially cooked dough), positioning the combined filler material 28 and uncooked or partially cooked bread material 26 in a heatable container 12, sealing the container 12, and applying heat to the container for a period of time sufficient to cook the bread material 26 to form the sandwich product 10. By way of example, a performed and appropriately sized portion of pita bread that has been substantially cooked to a state of doneness is filled with a mixture of ground sausage in a thickened base, such as tomato sauce. The filled pita bread portion is positioned in a container made of tin or other suitable metal or alloy and the container is sealed by known methods. The container is then heated to 350° F. for ten minutes until the pita bread and filler material are sufficiently cooked and combined.

Sandwich products of the type previously described may be placed directly into a container 12, or the sandwich product may be placed in a wrapper, such as a plastic enclosure, prior to sealing the container 12. If the sandwich product 10 is placed directly in the container, it may be desirable or necessary to provide an appropriate coating to the inside of the container. Those of skill in the industry of manufacturing containers for comestible products are knowledgeable with respect to the types of coatings that are appropriate for such use.

The sandwich products previously described are known to have a determined shelf life that may be suitable for vending in high traffic areas where product turnover is high. In other words, the shelf-life of such sandwiches may be from about five days to approximately three weeks, depending on the materials used and the moisture content of the sandwich product. The lower the moisture content, generally, the longer the shelf life of the product.

A most suitable product for use in the present invention may be a low-moisture, extended shelf-life sandwich product that has recently been developed by the United States military at the Natick Research Development and Engineering Center. The extended shelf-life sandwich products are known as MERC's, which stands for “mobility enhancing ration components.” MERC's have been developed to have a shelf-life of up to three years, and are highly mobile and quick to consume since no cooking or other preparation is required. MERC's are developed with high nutrition and low or no preservatives. An example of how a representative MERC is made is set forth in the following Example:

### EXAMPLE 1

In a clean room environment, raw meat product (e.g., beef, chicken, pork or fish) is reduced to small pieces of a size desirable for use in a sandwich and the meat product is optionally marinated by known methods. The meat product is then cooked at a temperature sufficient to kill pathogens (i.e., between 150° F. and 300° F.). The meat product is tested for pathogens by known methods. The cooked meat is then optionally mixed with a sauce, such as barbeque sauce, that has been cooked to a temperature sufficient to kill pathogens (e.g., 120° F.). Dough ingredients, including flour, calcium sulfate, sucrose ester, glycerin, encapsulated sorbic acid, xantham gum and encapsulated lactone, are mixed together and allowed to relax. The dough is then formed into flattened rectangular shapes in which a pocket is formed. The meat mixture, which has been cooled to ambient temperature, is placed in the pocket of the bread product and the formed sandwich is allowed to rest for approximately one hour. The formed sandwiches are then baked to an internal temperature of between 160° F. and 190° F. The sandwiches are then allowed to cool to ambient temperature, at which point the sandwiches are ready for packaging.

A sandwich prepared in accordance with Example 1 above is formed having dimensions suitable for being received in a container 12 (FIG. 1, 3 or 4) sized for dispensing from a vending machine that is structured for vending containerized beverages. The container 12 is sealed in a known manner to enclose the sandwich product 10 within the container 12.

In an alternative embodiment of the invention shown in FIG. 3, the container 12 may be filled with disparate food products while maintaining the dimensions 24 (height and circumference, for example) of the container 12 for dispensing from a vending machine structured to vend containerized beverages. Thus, by way of example only, the container 12 may comprise a cylindrical portion 14, a bottom 16 seal to the cylindrical portion 14 and a top 18 that is affixed to the cylindrical portion 14 in a manner that provides separation of all or a portion of the top 18 from the cylindrical portion 14 to provide access to the interior 22 of the container 12. An opening mechanism 20 is provided to remove the top 18 from the cylindrical portion 14.

In the embodiment shown in FIG. 2, the sandwich product 10 is reduced in dimension to fit within less than the entire interior 22 of the container 12. For example, the sandwich product 10 may be sized to fill two-thirds of the height 24 of the container 12. In this embodiment, the sandwich product 10 is shown, by way of example only, as being further contained within a clear plastic wrapper 30. However, as previously noted, it may be suitable or appropriate to place the sandwich product 10 directly in the container without first placing it in a wrapper 30.

A partition member 32 is positioned in the container 12 to divide the interior 22 of the container 12 into two compartments to house the disparate food products. The partition member 32 may preferably have a circumferential dimension, or has a perimeter shape, which approximates the circumferential dimension or shape of the container 12 so that the partition may be securely held within the container 12, such as by a friction fit. However, the partition member 32 may be held in place by any manner of suitable devices or means. The partition member 32 may be configured with, for example, a pull tab (not shown) that enables the user to remove the partition member 32 from the container 12 to access the sandwich product 10.

The partition member 32 provides a second compartment 34 in which another food product 36 may be positioned. By way of example only, the second compartment 34 is shown filled with a stack of potato chips. However, the food product 36 contained in the second compartment 34 may be any number of suitable items, including but not limited to nuts, corn chips, pretzels, cookies, candies, yogurt, puddings or gelatins, etc. The food product 36 may, as shown in FIG. 2, be placed in the second compartment without ancillary wrapping, or the food product 36 may be packaged in its own wrapper or packaging element (e.g., plastic wrapper, paper cup, plastic cup, etc.).

In use, the consumer removes the top 18 of the container 12 by the opening mechanism 20 provided to access the food product 36 in the second compartment 34. The partition member 32 is then removed to access the sandwich product 10 in the first compartment 38. It is equally suitable, that the sandwich product 10 may be contained in that compartment positioned closest to the top 18 while the other food product 36 is contained in that compartment that is positioned adjacent the bottom 16 of the container 12 thereby giving the consumer access first to the sandwich product 10 and then to the other food product 36.

It should be noted at this juncture that the opening mechanism 20 illustrated in the drawings herein is generally shown as a conventionally-known metal pull tab that, when lifted and pulled, causes a rupture of the metal top 18 from the metal cylindrical portion 14 so that the top 18 can be removed from the container 12. That type of opening mechanism is by way of example only. Numerous other known devices may be employed for structuring the top 18 and for providing removal of the top 18 from the container 12 to access the interior 22 thereof, including, but not limited to a foil top having a flexible foil pull tab, a plastic lid that seals around the circumference or perimeter top of the container 20, a paper or plastic pull string or ribbon that seals the top 18 to the upper edge of the cylindrical portion 14, etc. The type of top 18 and opening mechanism employed is not meant to be limited to that which is illustrated.

As further illustrated in phantom in FIG. 1, the container 12 may be provided with an opening mechanism 39 which comprises a pull tab that ruptures the cylindrical portion 14 of the container 12 to separate, partially or wholly, the cylindrical portion 14 from the top 18 and bottom 16 of the container 12 to provide access to the interior 22 of the container 12. Such opening mechanisms may be provided in a variety of materials from which the container 12 may be made, including cardboard, plastic and lightweight aluminum. Notably, a similar opening mechanism 39 may be employed with a container having at least two side-by-side compartments which, when the cylindrical portion 14 is ruptured, allows the container to open in a clam shell-like fashion.

In yet another alternative embodiment of the invention shown in FIG. 3, a container 12 may be provided which is comprised of separable compartments 40, 42 which are joined together in a manner which permits vending of the entire container 12 in a single unit. Thus, the overall combined height dimensions 44, 46, respectively, of the separable compartments 40, 42 approximates the dimensions of a beverage container beverage that is vendable from a vending machine structured to dispense such sized and dimensioned beverage containers.

The container 12 shown in FIG. 3 comprises a first compartment 40 that may be equal in area or, as shown in FIG. 3, smaller in area than a second compartment 42. The first compartment 40 comprises a cylindrical portion 48, a bottom 50 and a top 52 that may be separable from the cylindrical portion 48 by an opening mechanism 54. The first compartment contains a food product 56 that is different from the food product 58 contained in the second compartment 42. Likewise, the second compartment 42 comprises a cylindrical portion 60, a bottom 62 and a top 64 that may be separable from the cylindrical portion 60 by an opening mechanism 66. Notably, the compartments 40, 44 may each be structured with different opening mechanisms as previously described herein.

The first compartment 40 is separably joined to the second compartment 42 by any suitable means, such as a paper or plastic ribbon tab 68 that has, for example, an adhesive surface 70 that is oriented for placement against the first compartment 40 and second compartment 42. The ribbon tab 68 is sized to contact both the first compartment 40 and second compartment 42 as shown to join the structures together. Upon releasing the ribbon tab 68 from about the circumference of the compartments 40, 42, the two compartments 40, 42 may be separated from each other and the contents of each accessed through their respective opening mechanisms 54, 66. While the ribbon tab 68 is illustrated as fitting circumferentially about the two compartments 40, 42, the adhesived ribbon tab 68 may run lengthwise relative to both compartments 40, 42 and more than one ribbon tab 68 may be provided to contact both compartments 40, 42. Any other suitable device may be used to connect the first compartment 40 to the second compartment 42 in a separable manner.

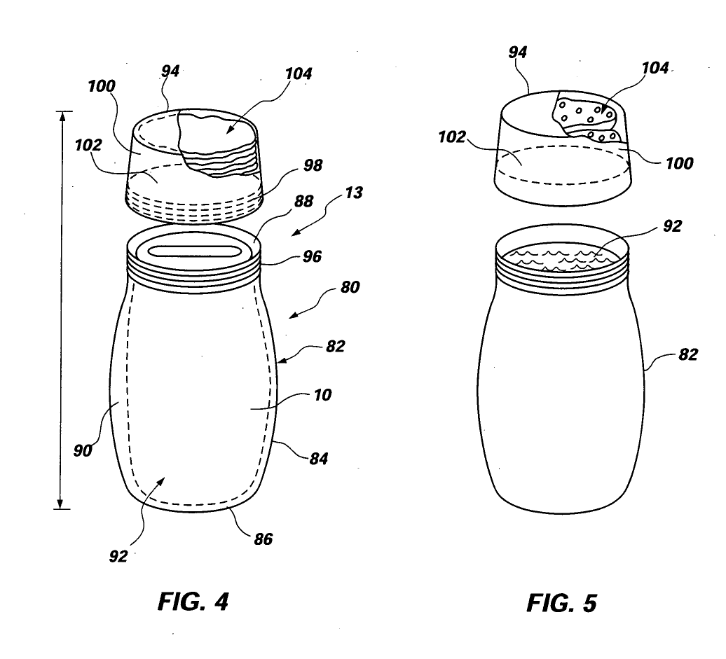

FIGS. 4 and 5 illustrate alternative embodiments of a container 80 which is generally structured to approximate the size and dimension of glass or plastic bottles currently popular for dispensing soft drinks (typically twenty ounce portions) from vending machines. The illustrated containers 80 are structured to contain food products, including a sandwich product, that may be vended along with glass or plastic beverage bottles from a vending machine structured to dispense such bottle containers. Consequently, the consumer is able to select, from a single vending machine, both beverages and non-beverage food products.

The containers 80 of the illustrated embodiment generally comprise a food product-enclosing portion 13 that is not strictly cylindrical, but may have any conceivable shape or dimension in axial cross section (i.e., a section taken through the long axis of the container 80). As illustrated by way of example only, the container 80 has a generally hourglass configuration. In this embodiment, the container 80 comprises a main food product-enclosing compartment 82 having a wall portion 84, a closed bottom 86 and an open top 88, all of which define an interior space 90 that is sized to receive a food product 92, shown in FIG. 4 as being a sandwich-like product 10.

The container 80 further comprises a lid 94 that is securable in some suitable manner to the main food product-enclosing compartment 82. For example, the main food product-enclosing compartment 82 has a threaded neck region 96 and the lid 94 has a threaded band region 98 that is complimentary thereto, allowing the lid 94 to be threaded onto and off of the main food product-enclosing compartment 82. The lid 94 may comprise a hollow space such that, when a sandwich-like product 10, for example, is positioned in the main food product-enclosing compartment 82, the sandwich-like product 10 may extend into the space of the lid 94, thereby facilitating the removal of the sandwich-like product 10 from the container 80.

Alternatively as shown in FIG. 4, the lid 84 may have an interior space 100 that may be made separable from the main food product-enclosing compartment 82 by, for example, a removable partition member 102. Thus, the interior space 100 of the lid 94 may be employed as a separate compartment of the container 80 to retain a disparate food product 104 therein. As shown by way of example only, the food product 104 contained in the lid 94 is a stack of potato chips. However, the disparate food product 104 may be any number of food product items as previously described, including but not limited to savory snack products, nuts, potato or corn chips, pretzels, cookies, crackers, candy, gelatinous desserts, dairy-based desserts or condiments, including cream cheese.

FIG. 5 illustrates an alternative embodiment of the present invention where the main food-product enclosing compartment 82 of the container 80 may be filled with a liquid beverage product, such as milk, although any conceivable beverage product may be used. The interior space 100 of the lid 94, which is separated from the main food product-enclosing compartment 82 by a partition member 102, is filled with a disparate food product 104, here illustrated as cookies. Thus, from a vending machine that otherwise dispenses containerized beverages, and principally soft drinks, the consumer may select to vend a container of milk and cookies, by way of example only.

As used herein, the term “disparate food product” is meant to imply that the food products are not identical (e.g., not both peanuts). However, the “disparate food products” may include foods (including liquids) that are of a similar nature, character, category, food group or other distinguishing term. For example, the separate compartments of the containers described herein may both contain nuts, however, one compartment contains a different kind of nut from the other (e.g., peanuts and cashews). Likewise, the compartments may contain two items characterized as snack foods, but of a different nature, such as potato chips and corn chips, or plain potato chips in one compartment and flavored potato chips in the other compartment.

Similarly, the compartments may both contain liquids, but of a different type or nature (e.g., milk in one compartment and soda in the other compartment, or a quantum of alcohol in one compartment and a mixer in the other compartment by which a cocktail may be made). Additionally, the present invention includes the dispensing of both food products and non-food products together in a single container sized and dimensioned for dispensing from a vending machine structured to vend beverages. By way of example only, one of the compartments may contain a snack product like caramel popcorn and the other compartment may contain a prize.

The container of the present invention may even have one compartment filled with a food product and the other compartment sized to contain a utensil or other item for consuming the food product. Additionally, the compartments of the container may both contain disparate non-food or non-comestible items (e.g., shampoo in one compartment and conditioner in the other compartment, or playing cards in one compartment and playing chips in the other compartment). As used herein, “non-food” or “non-comestible” products or items are those which have utility to a person and are not intended to include non-utilitarian items such as weights placed in the container to aid in vending of the container or prize notification devices, etc.

It should also be noted that the containers described and illustrated herein comprise two separated compartments. However, it is within the scope of the invention that more than two compartments may be provided in a single container, as long as the overall container is sized and shaped to be dispensed from a vending machine that is structured to vend containerized beverages.

The present invention has the principal objective of providing the consumer with a variety of food products, or food or non-food products, from a single vending machine, namely a vending machine that is structured for vending containerized beverages. However, another objective of the present invention is to provide a handy and expedient means for providing one or more food products in a container that is also available from retail or grocery store shelves, thereby enabling the consumer to purchase a containerized food product that, for example, may be packed for outdoor activities such as picnicking, camping, hiking or extended travel. Thus, those of skill in the art will comprehend that modifications may be made to the containers described and illustrated herein for retaining various food products, and for accessing such food products from the containers. Therefore, references made herein to the containers or methods described and illustrated are by way of example only, and not by way of limitation.

1. A vendable, non-beverage food product, comprising:
a container sized and shaped for being dispensable from a vending machine structured to vend containerized beverages, said container having a food product-enclosing portion, a top, a bottom and an opening mechanism for accessing the interior of said food product-enclosing portion; and
a sandwich-like product contained within said container, said sandwich-like product having a selected shelf-life.

2. The vendable, non-beverage food product of claim 1 wherein said sandwich-like product further comprises a bread-like portion and filler material.

3. The vendable, non-beverage food product of claim 2 wherein said filler material is in contact with said bread-like portion.

4. The vendable, non-beverage food product of claim 1 wherein said sandwich-like product has a shelf-life of up to three years.

5. The vendable, non-beverage food product of claim 1 wherein said sandwich-like product is enclosed in a wrapper.

6. The vendable, non-beverage food product of claim 1 wherein said container is divided into a first compartment and a second compartment, said sandwich-like product being contained in one of said first compartment or second said compartment, and the other compartment containing a disparate food product.

7. The vendable, non-beverage food product of claim 6 wherein said disparate food product is a non-beverage.

8. The vendable, non-beverage food product of claim 7 wherein said disparate food product is selected from the group comprising savory snacks, chips, nuts, cookies, candy, yogurt, gelatinous desserts or dairy-containing desserts.

9. The vendable, non-beverage food product of claim 1 wherein said container is further comprised of separable compartments separably affixed together for dispensing, wherein each said separable compartment further comprises a food product-enclosing portion, a top, a bottom and an opening mechanism for accessing the interior of said food-product-enclosing portion, and each said separable compartment of said container contains a disparate food product.

10. A vendable combination of food products, comprising:
a vendable container sized and shaped for being dispensable from a vending machine structured to vend containerized beverages, said container having a food product-enclosing portion, a top, a bottom and an opening mechanism for accessing the interior of said food product-enclosing portion; and
at least two disparate food products contained within said container.

11. The vendable combination of food products of claim 10 wherein said vendable container is comprised of separated compartments each sized to contain a disparate food product.

12. The vendable combination of food products of claim 11 wherein said vendable container comprises a single food product-enclosing portion which is separated into compartments by a movable partition member.

13. The vendable combination of food products of claim 11 wherein said vendable container comprises separable compartments, each compartment comprising a food product-enclosing portion, a bottom and an opening mechanism for accessing the interior of each said compartment.

14. The vendable combination of food products of claim 13 wherein at least one of said disparate food products is a sandwich-like product.

15. The vendable combination of food products of claim 13 wherein at least one of said disparate food products is a beverage and another of said disparate food products is cookies.

16. The vendable combination of food products of claim 10 wherein at least one of said disparate food products is a sandwich-like product.

17. The vendable combination of food products of claim 10 wherein at least one of said disparate food products is a beverage.

18. A method for dispensing a sandwich-like product from a vending machine structured to vend containerized beverages, comprising:
providing a vendable container sized and shaped for being dispensable from a vending machine structured to vend containerized beverages, said container having a food product-enclosing portion, a top, a bottom and an opening mechanism for accessing the interior of said food product-enclosing portion;
filling said vendable container with a sandwich-like product;
placing said vendable container filled with a sandwich-like product in a vending machine structured for vending containerized beverages; and
providing a selection mechanism by which a consumer may select for the vending from the machine of a vendable container filled with a sandwich-like product.

19. The method according to claim 18 wherein said vendable container is further structured with more than one compartment, each compartment being separately structured to contain a disparate food product from that contained in another compartment.

20. A method for dispensing a combination of food products, contained in a vendable container, from a vending machine structured to vend containerized beverages, comprising:
providing a vendable container sized and shaped for being dispensable from a vending machine structured to vend containerized beverages, said container having a food product-enclosing portion, a top, a bottom and an opening mechanism for accessing the interior of said food product-enclosing portion;
filling said vendable container with at least two disparate food products;
placing said vendable container filled with said at least two disparate food products in a vending machine structured for vending containerized beverages; and
providing a selection mechanism by which a consumer may select for the vending from the machine of a vendable container filled with at least two disparate food products.

21. The method according to claim 20 wherein one of said at least two disparate food products is a sandwich-like product.

22. The method according to claim 20 wherein one of said at least two disparate food products is a beverage and another of said at least two disparate food products is a non-beverage.

23. A vendable combination of products, comprising:
a vendable container sized and shaped for being dispensable from a vending machine structured to vend containerized beverages, said container having a product-enclosing portion, a top, a bottom and an opening mechanism for accessing the interior of said product-enclosing portion; and
at least two disparate products contained within said container.

24. The vendable combination of products as set forth in claim 23 wherein one of said at least two disparate products is a comestible product.

25. The vendable combination of products as set forth in claim 24 wherein one of said at least two disparate products is a non-comestible product.

26. The vendable combination of products as set forth in claim 23 wherein said at least two disparate products are both utilitarian, non-comestible products.
